(19) United States
(12) Patent Application Publication
(10) Pub. No.: US 2024/0103520 A1
(43) Pub. Date: Mar. 28, 2024

(54) METHOD AND SYSTEM FOR CONTROLLING MOVEMENT OF AUTONOMOUS MOBILE APPARATUS

(71) Applicant: URSrobot AI Inc., Taipei City (TW)

(72) Inventors: Chien-Tung CHEN, Taipei City (TW); Chung-Hou WU, Taipei City (TW); Chao-Cheng CHEN, Taipei City (TW); Wen-Wei CHIANG, Taipei City (TW)

(21) Appl. No.: 18/472,016

(22) Filed: Sep. 21, 2023

(30) Foreign Application Priority Data
Sep. 23, 2022 (TW) 111136246

(51) Int. Cl. G05D 1/02

(52) U.S. Cl. CPC G05D 1/0217; G05D 1/0223

(57) ABSTRACT

A method of controlling movement of an autonomous mobile apparatus including a driving module, a processor, and a positioning module includes steps of: the processor moving the autonomous mobile apparatus at a default speed from a first location toward a second location along a straight path; the positioning module obtaining data related to a current location; when the processor determines that a distance between the current location and the second location is greater than a predetermined distance, the processor obtaining a deviating direction and a minimum distance of the current location relative to the straight path; the processor setting a movement speed and an angular velocity based on the deviating direction, a tolerant distance, the minimum distance, and the default speed; and the processor controlling the driving apparatus to move the autonomous mobile apparatus at the movement speed and turning the autonomous mobile apparatus at the angular velocity.

### CROSS-REFERENCE TO RELATED APPLICATION

This application claims priority to Taiwanese Invention Patent Application No. 111136246, filed on Sep. 23, 2022.

### FIELD

The disclosure relates to a method and a system for controlling movement of an apparatus, and more particularly to a method and a system for controlling movement of an autonomous mobile apparatus.

### BACKGROUND

An autonomous mobile apparatus, such as a robot lawn mower, may have an issue of deviating from a predetermined path due to depressions in the ground surface or tall and dense weeds. A conventional autonomous mobile apparatus disclosed in Chinese Patent Application Publication No. CN111176282A is configured to select a plurality of inflection points, set a boundary by connecting the inflection points, and move within a range defined by the boundary. However, the issue of deviating from the predetermined path is unsolved.

### SUMMARY

Therefore, an object of the disclosure is to provide a method and a system for controlling movement of an autonomous mobile apparatus that can alleviate at least one of the drawbacks of the prior art.

According to the disclosure, a method of controlling movement of an autonomous mobile apparatus from a first location to a second location through a straight path is provided. The autonomous mobile apparatus includes a driving module for moving the autonomous mobile apparatus, a processor for controlling operation of the driving module, and a positioning module for obtaining a location of the autonomous mobile apparatus. The method includes steps of: A) the processor obtaining first location data, second location data and path data respectively corresponding to the first location, the second location and the straight path; B) the processor outputting a first control signal related to a default speed to the driving module for controlling the driving module to move the autonomous mobile apparatus toward the second location at the default speed; C) the positioning module obtaining current location data corresponding to a current location of the autonomous mobile apparatus; D) the processor determining a distance between the current location and the second location based on the current location data and the second location data, and determining whether the distance between the current location and the second location is greater than a predetermined distance; E) when it is determined that the distance between the current location and the second location is greater than the predetermined distance, the processor obtaining a deviating direction and a minimum distance of the current location relative to the straight path based on the current location data and the path data; F) the processor setting a movement speed of the autonomous mobile apparatus based on a tolerant distance, the minimum distance, and the default speed; G) the processor setting an angular velocity for adjusting a moving direction of the automatous mobile apparatus based on the deviating direction and the minimum distance; H) the processor outputting a second control signal related to the movement speed and the angular velocity to the driving module for controlling the driving module to move the autonomous mobile apparatus toward the second location at the movement speed and to adjust the moving direction of the autonomous mobile apparatus by turning the autonomous mobile apparatus at the angular velocity to gradually approach the straight path; and I) repeating steps C) to H) until the processor determines that the distance between the current location and the second location is not greater than the predetermined distance.

According to the disclosure, a system for controlling movement of an autonomous mobile apparatus from a first location to a second location through a straight path is provided. The autonomous mobile apparatus includes a driving module configured to move the autonomous mobile apparatus. The system includes a storage medium, a positioning module, and a processor. The storage medium is configured to store first location data, second location data, and path data that respectively correspond to the first location, the second location, and the straight path. The positioning module is configured to continuously obtain current location data that corresponds to a current location of the autonomous mobile apparatus. The processor is electrically connected to the storage medium and the positioning module, and the processor is configured to be electrically connected to the driving module and to implement operations of: a) obtaining the first location data, the second location data, and the path data from the storage medium; b) outputting a first signal related to a default speed to the driving module for controlling the driving module to move the autonomous mobile apparatus toward the second location at the default speed; c) obtaining current location data from the positioning module; d) determining a distance between the current location and the second location based on the current location data and the second location data, and determining whether the distance between the current location and the second location is greater than a predetermined distance; e) when determining that the distance between the current location and the second location is greater than the predetermined distance, obtaining a deviating direction and a minimum distance of the current location relative to the straight path based on the current location data and the path data; f) setting a movement speed of the autonomous mobile apparatus based on a tolerant distance, the minimum distance, and the default speed; g) setting an angular velocity for adjusting moving direction of the autonomous mobile apparatus based on the deviating direction and the minimum distance; h) outputting a second signal related to the movement speed and the angular velocity to the driving module for controlling the driving module to move the autonomous mobile apparatus toward the second location at the movement speed and to adjust moving direction of the autonomous mobile apparatus by turning the autonomous mobile apparatus at the angular velocity to gradually approach the straight path; and i) repeating the operations c) to h) until the processor determines that the distance between the current location and the second location is less than or equal to the predetermined distance.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating an autonomous mobile apparatus according to an embodiment of the disclosure.

FIG. 2 is a flow chart illustrating a method of controlling movement of the autonomous mobile apparatus according to an embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

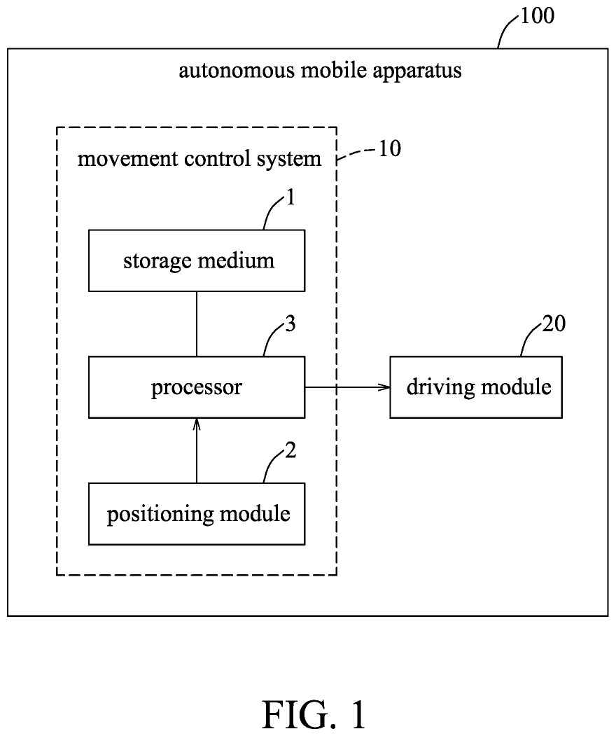

Referring to FIG. 1, an autonomous mobile apparatus 100 according to an embodiment of the disclosure includes a movement control system and a driving module 20. In this embodiment, the autonomous mobile apparatus 100 may be implemented by a robot lawn mower that is configured to mow lawns of a golf course or a park. The driving module 20 may include, but not limited to, a motor (not shown) for controlling moving speed of the autonomous mobile apparatus 100, and a direction control component (not shown) for controlling movement direction of the autonomous mobile apparatus 100. For example, the direction control component may be implemented by a microcontroller for controlling a wheel to turn. In some embodiments, the autonomous mobile apparatus 100 may be implemented by a sweeping robot, a mopping robot, or other types of autonomous mobile apparatus.

In this embodiment, the movement control system 10 is configured to control movement of the autonomous mobile apparatus 100 from a first location to a second location through a straight path. The movement control system 10 includes a storage medium 1, a positioning module 2, and a processor 3 that is electrically connected to the driving module 20, the storage medium 1, and the positioning module 2.

The storage medium 1 may be implemented by, for example, a read only memory (ROM), a random access memory (RAM), a memory card, or any other device that is configured to store digital data. The storage medium 1 stores first location data, second location data, and path data that respectively correspond to the first location, the second location, and the straight path. The first location data, the second location data, and the path data may include information such as longitude and latitude coordinates. For example, the first location data includes a set of longitude and latitude coordinates of the first location, the second location data includes a set of longitude and latitude coordinates of the second location, and the path data includes multiple sets of longitude and latitude coordinates respectively of multiple geographical points along the straight path.

The positioning module 2 may use, for example, real time kinematic (RTK) positioning technique, a global navigation satellite system (GNSS), ultra-wideband (UWB) technology, an inertial navigation system (INS), etc., to obtain location data of a location of the autonomous mobile apparatus 100. In this embodiment, the positioning module 2 is configured to continuously obtain current location data that corresponds to a current location (e.g., a location in the golf course or the park) of the autonomous mobile apparatus 100. The current location data may include information such as a set of longitude and latitude coordinates.

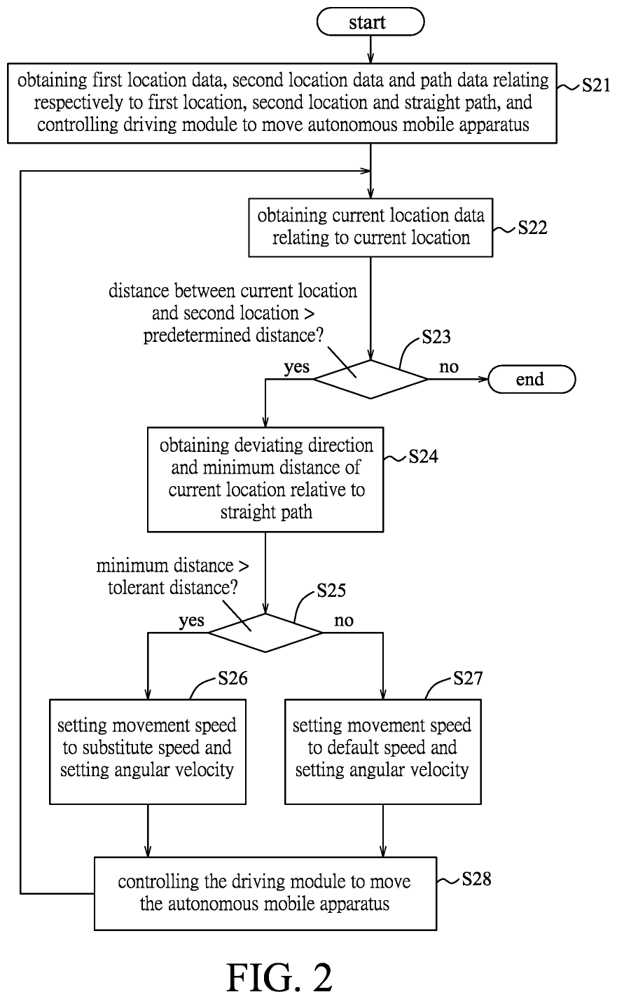

Further referring to FIG. 2, a method of controlling movement of the autonomous mobile apparatus 100 from the first location to the second location through the straight path is provided. The method is to be performed by the processor 3 and includes steps S21 to S28.

In step S21, the processor 3 obtains the first location data, the second location data, and the path data from the storage medium 1. The processor 3 then outputs a first control signal that is related to a default speed to the driving module 20 for controlling the driving module 20 to move the autonomous mobile apparatus 100 toward the second location at the default speed. The default speed may be between 0.5 to 10 meters per second. In this embodiment, the default speed may be, for example, 0.6 meters per second. It should be noted that the default speed may vary depending on the application and the size of the autonomous mobile apparatus 100, and should not be limited to the abovementioned example.

In step S22, the processor 3 obtains the current location data from the positioning module 2.

In step S23, the processor 3 determines a distance between the current location and the second location based on the current location data and the second location data. The processor 3 then determines whether the distance between the current location and the second location is greater than a predetermined distance. The predetermined distance may be between 5 to 20 centimeters. In this embodiment, the predetermined distance may be, for example, centimeters. It should be noted that the predetermined distance depends on an accuracy of the positioning module 2, or the application and size of the autonomous mobile apparatus 100, and should not be limited to the abovementioned example. When the processor 3 determines that the distance between the current location and the second location is greater than the predetermined distance, the flow proceeds to step S24. Otherwise, when the processor 3 determines that the distance between the current location and the second location is not greater than the predetermined distance, it may be considered that the autonomous mobile apparatus 100 has reached the second location, and the flow of the method is terminated.

In step S24, the processor 3 obtains a deviating direction and a minimum distance of the current location relative to the straight path based on the current location data and the path data. The minimum distance is defined as a length of a straight line that extends perpendicularly from the straight path to the current location. In this embodiment, the deviating direction is either to the left or to the right of the straight path.

In step S25, the processor 3 determines whether the minimum distance is greater than a tolerant distance. The tolerant distance may be shorter than 10 centimeters. In this embodiment, the tolerant distance may be, for example, 3 centimeters. It should be noted that the tolerant distance may vary depending on the application and the size of the autonomous mobile apparatus 100, and should not be limited to the abovementioned example. If the processor 3 determines that the minimum distance is greater than the tolerant distance, the flow proceeds to step S26; otherwise, the flow proceeds to step S27.

In step S26, the processor 3 sets a movement speed of the autonomous mobile apparatus 100 to a substitute speed, and sets an angular velocity for adjusting a moving direction of the autonomous mobile apparatus 100 based on the deviating direction and the minimum distance. Specifically, the substitute speed is less than the default speed.

In this embodiment, the substitute speed is equal to half of the default speed, and a magnitude of the angular velocity is directly proportional to the minimum distance. For example, the magnitude of the angular velocity is equal to one-tenth of the value of the minimum distance. According to the abovementioned example, the default speed is 0.6 meters per second, and assuming that the minimum distance is fifteen centimeters and the deviating direction is, for example, to the left of the straight path, then the substitute speed is determined to be 0.3 meters per second, and the angular velocity is determined to be, for example, (+) 1.5 radians per second, where the sign (+) indicates clockwise rotation. In some embodiments, the substitute speed may be, but not limited to, a speed that is less than half of the default speed, such as one-third of the default speed.

It should be noted that, in step S26, the processor 3 does not set the movement speed and the angular velocity in a specific order, meaning that either of the movement speed and the angular velocity may be set first, or the movement speed and the angular velocity may be set at the same time.

In step S27, the processor 3 sets the movement speed of the autonomous mobile apparatus 100 to the default speed, and sets the angular velocity for adjusting the moving direction of the autonomous mobile apparatus 100 based on the deviating direction and the minimum distance. According to the abovementioned example, the default speed is 0.6 meters per second, and assuming that the minimum distance is one centimeter and the deviating direction is, for example, to the right of the straight path, then the movement speed is determined to be 0.6 meters per second, and the angular velocity is determined to be, for example, (−) 0.1 radians per second, where the sign (−) indicates counterclockwise rotation.

After performing either step S26 or step S27, the flow proceeds to step S28, and in step S28, the processor 3 outputs a second control signal that is related to the movement speed and the angular velocity to the driving module 20. In response to receipt of the second control signal, the driving module 20 then moves the autonomous mobile apparatus 100 toward the second location at the movement speed and adjusts the moving direction of the autonomous mobile apparatus 100 by turning the autonomous mobile apparatus 100 at the angular velocity to gradually approach the straight path. To describe in further detail, the motor of the driving module 20 drives the autonomous mobile apparatus 100 to move based on the movement speed, and the direction control component of the driving module 20 adjusts the autonomous mobile apparatus 100 to rotate based on the angular velocity, thus moving the autonomous mobile apparatus 100 toward the second location while gradually approaching the straight path.

To ensure that the autonomous mobile apparatus 100 is moving along the straight path and toward the second location, the processor 3 is configured to repeatedly perform steps S22 to S28 (i.e., S22 to S25, either S26 or S27, and S28) until the processor 3 determines in step S23 that the distance between the current location and the second location is not greater than the predetermined distance.

It should be noted that, in a case where the autonomous mobile apparatus 100 is a robot lawn mower and an area to be mowed is very large, the area may be divided into a plurality of straight paths, and the first location, the second location, and the path data corresponding to each one of the straight paths is pre-stored in the storage medium 1. Then, the processor 3 may perform the abovementioned method for the straight paths one by one, thus mowing the area completely.

In summary, the movement control system 10 is configured to continuously monitor the autonomous mobile apparatus 100 while the autonomous mobile apparatus 100 is moving along the straight path toward the second location. When the processor 3 determines that the minimum distance of the current location relative to the straight path is larger than the tolerant distance, the processor 3 sets the movement speed to less than the default speed, and sets a relatively large angular velocity for adjusting the movement direction of the autonomous mobile apparatus 100 to gradually approach the straight path; when the processor 3 determines that the minimum distance is not larger than the tolerant distance, the processor 3 sets the movement speed back to the default speed, and sets a relatively small angular velocity for adjusting the movement direction of the autonomous mobile apparatus 100 to gradually approach the straight path.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method of controlling movement of an autonomous mobile apparatus from a first location to a second location through a straight path, the autonomous mobile apparatus including a driving module for moving the autonomous mobile apparatus, a processor for controlling operation of the driving module, and a positioning module for obtaining location data corresponding to a location of the autonomous mobile apparatus, the method comprising steps of:
A) the processor obtaining first location data, second location data and path data respectively corresponding to the first location, the second location and the straight path;
B) the processor outputting a first control signal related to a default speed to the driving module for controlling the driving module to move the autonomous mobile apparatus toward the second location at the default speed;
C) the positioning module obtaining current location data corresponding to a current location of the autonomous mobile apparatus;
D) the processor determining a distance between the current location and the second location based on the second location data and the current location data obtained from the positioning module, and determining whether the distance between the current location and the second location is greater than a predetermined distance;
E) when it is determined that the distance between the current location and the second location is greater than the predetermined distance, the processor obtaining a deviating direction and a minimum distance of the current location relative to the straight path based on the current location data and the path data;
F) the processor setting a movement speed of the autonomous mobile apparatus based on a tolerant distance, the minimum distance, and the default speed;
G) the processor setting an angular velocity for adjusting a moving direction of the automatous mobile apparatus based on the deviating direction and the minimum distance;
H) the processor outputting a second control signal related to the movement speed and the angular velocity to the driving module for controlling the driving module to move the autonomous mobile apparatus toward the second location at the movement speed and to adjust the moving direction of the autonomous mobile apparatus by turning the autonomous mobile apparatus at the angular velocity to gradually approach the straight path; and
I) repeating steps C) to H) until the processor determines that the distance between the current location and the second location is not greater than the predetermined distance.

2. The method as claimed in claim 1, wherein step F) includes:
determining whether the minimum distance is greater than the tolerant distance;
when the processor determines that the minimum distance is greater than the tolerant distance, setting the movement speed to a substitute speed, where the substitute speed is different from the default speed; and
when the processor determines that the minimum distance is not greater than the tolerant distance, setting the movement speed to the default speed.

3. The method as claimed in claim 2, wherein the substitute speed is less than the default speed.

4. The method as claimed in claim 3, wherein the substitute speed is less than half of the default speed.

5. The method as claimed in claim 3, wherein the substitute speed is equal to half of the default speed.

6. The method as claimed in claim 1, wherein the angular velocity has a direction related to the deviating direction, and a magnitude directly proportional to the minimum distance.

7. A system for controlling movement of an autonomous mobile apparatus from a first location to a second location through a straight path, the autonomous mobile apparatus including a driving module configured to move the autonomous mobile apparatus, said system comprising:
a storage medium configured to store first location data, second location data, and path data respectively corresponding to the first location, the second location, and the straight path;
a positioning module configured to continuously obtain current location data corresponding to a current location of the autonomous mobile apparatus; and
a processor electrically connected to said storage medium and said positioning module, said processor being configured to be electrically connected to the driving module and to implement operations of:
a) obtaining the first location data, the second location data, and the path data from said storage medium,
b) outputting a first signal related to a default speed to the driving module for controlling the driving module to move the autonomous mobile apparatus toward the second location at the default speed,
c) obtaining current location data from said positioning module,
d) determining a distance between the current location and the second location based on the current location data and the second location data, and determining whether the distance between the current location and the second location is greater than a predetermined distance,
e) when determining that the distance between the current location and the second location is greater than the predetermined distance, obtaining a deviating direction and a minimum distance of the current location relative to the straight path based on the current location data and the path data,
f) setting a movement speed of the autonomous mobile apparatus based on a tolerant distance, the minimum distance, and the default speed,
g) setting an angular velocity for adjusting a moving direction of the autonomous mobile apparatus based on the deviating direction and the minimum distance,
h) outputting a second signal related to the movement speed and the angular velocity to the driving module for controlling the driving module to move the autonomous mobile apparatus toward the second location at the movement speed and to adjust the moving direction of the autonomous mobile apparatus by turning the autonomous mobile apparatus at the angular velocity to gradually approach the straight path, and
i) repeating the operations c) to h) until said processor determines that the distance between the current location and the second location is less than or equal to the predetermined distance.

8. The system as claimed in claim 7, wherein, in the operation f), said processor is configured to:
determine whether the minimum distance is greater than the tolerant distance;
when said processor determines that the minimum distance is greater than the tolerant distance, set the movement speed to a substitute speed, where the substitute speed is different from the default speed; and
when said processor determines that the minimum distance is not greater than the tolerant distance, set the movement speed to the default speed.

9. The system as claimed in claim 8, wherein the substitute speed is less than the default speed.

10. The system as claimed in claim 9, wherein the substitute speed is less than half of the default speed.

11. The system as claimed in claim 9, wherein the substitute speed is equal to half of the default speed.

12. The system as claimed in claim 7, wherein the angular velocity has a direction related to the deviating direction, and a magnitude directly proportional to the minimum distance.
